(19) United States
(12) Patent Application Publication
(10) Pub. No.: US 2010/0223188 A1
(43) Pub. Date: Sep. 2, 2010

(54) Online Payment System and Method

(75) Inventor: Zheng Yang, Hangzhou (CN)

Correspondence Address: LEE & HAYES, PLLC, 601 W. RIVERSIDE AVENUE, SUITE 1400, SPOKANE, WA, 99201, US

(73) Assignee: ALIBABA GROUP HOLDING LIMITED, Grand Cayman (KY)

(21) Appl. No.: 11/997,767

(22) PCT Filed: Feb. 1, 2008
(86) PCT No.: PCT/US08/52765

§ 371 Date: Dec. 14, 2009

(30) Foreign Application Priority Data
Feb. 1, 2007 (CN) 200710006365.5

(51) Int. Cl. G06Q 20/00; H04L 9/32

(52) U.S. Cl. 705/75; 705/40; 705/44

(57) ABSTRACT

An online payment system uses an electronic check system to make a payment to a merchant on behalf of an online customer. The electronic check system receives a check application request of the customer, creates an electronic check number and a password for the check, outputs the check information to the customer, and stores the check information in the electronic check system. When a merchant system receives an online payment request of the customer, it sends the request to the electronic check system, which then parses out a payment electronic check number and a payment check password from the payment request, verifies the parsed information with the stored check the information, and makes a payment to the merchant. The electronic check system is centralized and shared by multiple merchants. A payment only needs access to the electronic check system, without requiring participation of multiple receipt-acquiring systems of individual merchants.

### RELATED APPLICATIONS

This application is a national stage application of international patent application PCT/US08/52765, filed Feb. 1, 2008, claiming priority from Chinese patent application, Application No. 200710006365.5, filed Feb. 1, 2007, both entitled “ONLINE PAYMENT SYSTEM AND METHOD”.

### BACKGROUND

This invention relates to the field of online commerce, particularly to online payment systems based on an electronic payment platform and corresponding online payment methods.

FIG. 1 illustrates an online payment system commonly used for online commerce today. The online payment system includes merchant systems 110 and receipt-acquiring systems 120. Each online merchant has its own separate merchant system 110 and conducts business with multiple financial institutions such as banks through their corresponding acquiring vendors. Each receipt-acquiring system 120 provides document-acquiring (such as receipt-acquiring, either electronic or paper in) services between a merchant and a bank (not shown) to facilitate payment transactions. A merchant negotiates with many different banks to become their contracted merchant. Each merchant system 110 needs to have installed thereupon the transaction platforms of all banks that have signed contracts with the merchant. To conduct an online commercial transaction, a customer may needs to visit a business branch of a bank that has a contract with the merchant, manually sign a service contract (e.g., open a bank account), and then conduct a payment transaction through the receipt-acquiring system 120 used by the merchant system 110 and the bank. The merchant then works with the bank for other transactions such as account check and account remittance.

The above illustrated payment transaction has several problems. First, from the perspectives of the merchant, in order to have more customers using online trade, it is required to negotiate with as many as possible banks in order to become their contracted merchant. Each bank has its corresponding transaction platform. This requires the merchant system 110 to install many different types of corresponding transaction platforms. Moreover, transactions such as account check have to be processed with each individual bank. That means that the merchant needs to spend a great deal of resources and manpower to manage and maintain such a online payment system.

In order to limit the cost of conducting online payment, the merchant may adopt another strategy, in which the merchant signs contracts with just a limited number of banks to process the online payment. Under this online payment strategy, customers are required to have an online payment card of at least one of the banks that have contracted with the merchant. This practice seriously restricts the customer usage as it merely transfers the burden from the merchant to customers.

From the perspectives of a bank, it needs to deal separately with millions of merchants, and set up or contract with corresponding acquiring systems to facilitate payments. Not only does this require lots of maintenance of the receipt-acquiring systems 110, it also requires tremendous resources and operating expenses to process various necessary transactions such as account check and account remittance with every individual merchant. More importantly, since the bank needs to sign a contract with each merchant separately and process online payment transactions with each merchant separately, there exists a potential serious security problem.

As such, another online payment method exists in the existing technologies to solve some of the problems. FIG. 2 illustrates an example of an alternative online payment system found in the existing technologies. The online payment system includes merchant systems 210, intermediary platform 230 and receipt-acquiring systems 220, wherein each merchant system 210 and each receipt-acquiring system 220 connects with intermediary platform 230. Each receipt-acquiring system 220 provides document-acquiring services between a merchant and a bank (not shown) to facilitate payment transactions. The intermediary platform 230 acts as a bridge between the merchants and the bank, and is used to carry out functions such as payment processing, fund settlement and query statistics.

When merchant system 210 receives from a customer a payment request, it accesses the corresponding receipt-acquiring system 220 through intermediary platform 230, and requests or instructs the receipt-acquiring system 220 to process the online payment request. The receipt-acquiring system 220 sends the payment processing result through intermediary platform 230 to the corresponding merchant system 210. Afterwards merchant system 210 continues to complete the remaining transaction processing according to the processing result. Merchant system 210, intermediary platform 230 and receipt-acquiring system 220 together perform tasks such as account check and account remittance. The online payment system in FIG. 2 provides a more convenient payment platform, makes electronic commerce services such as B2B and B2C trading less difficult, and provides further supports to many other value-added services for the merchants.

However, the payment system of FIG. 2 still has several potential defects. First, every time when an online trade is made, the merchant is required to access the corresponding receipt-acquiring system 220 through intermediary platform 230. The process requires multiple data transfers during every online trade, including accessing intermediary platform 230 first; accessing receipt-acquiring system 220 through intermediary platform 230; and after processing by receipt-acquiring system 220, returning to merchant system 210 through intermediary platform 230. The process thus causes a long processing time for a payment transaction. The processing time for each transaction can be particularly long when the network is busy, easily creating a burden on the whole network, and also increasing the development and maintenance costs of the overall online trading business.

Second, the payment method of FIG. 2 still has limitations due to localization of the customer usage. Under the payment method of FIG. 2, a customer is required to have an online payment card of the bank used for the transaction. This is cumbersome because the customer usually needs to visit each bank's local business office or a physical point of the service network to manually sign a contract in order to obtain an online payment card. At present many medium and smaller cities in some countries do not have easy access to such branch offices or service locations of a bank that provides suitable online payment services. As a result, for many customers, online payment is unavailable.

Third, with the above-described payment method, a customer is required to enter important information in every payment process. For example, customer needs to directly enter bank card number and password for debit processing in the corresponding bank for each online payment. This practice poses significant hidden security risks. If the important information entered is illegally acquired by someone else, it may pose harm to the customer.

Given the increasing importance of online payment and the shortcoming of the existing technologies, there is a need to develop new online payment systems and methods to improve various aspects of the service.

### SUMMARY

The present description discloses an online payment system that uses an electronic check system to make a payment to a merchant on behalf of an online customer. The electronic check system receives a check application request of the customer, creates an electronic check number and a password for the check, outputs the check information to the customer, and stores the check information in the electronic check system. When a merchant system receives an online payment request of the customer, it sends the request to the electronic check system, which then parses out a payment electronic check number and a payment check password from the payment request, verifies the parsed check information with the stored check the information, and makes a payment to the merchant. The electronic check system is centralized and shared by multiple merchants, and all payments need only to access the electronic check system, without requiring multiple receipt-acquiring systems for each individual merchant. A customer may establish a customer account with the electronic check system and use the account to fund electronic checks. The customer account may be opened and recharged online using various funding methods including cash and e-currencies.

The electronic check system has an application receiving module to receive electronic check information from a customer. This may be embodied in a user terminal which is connected to a central electronic check processing unit through an intranet, the Internet or a special designated line. The electronic check system has a check generating module used to generate a check information packet based on the electronic check application. The check generating module may either be embodied in the user terminal or as a part of a check server. The electronic check system sends the check information packet to the customer, and also saves a copy of the check information in a storage, which may either be a part of the central check server or a separate storage device. A variety of methods may be used to present the check information to the customer.

The electronic check processing module receives an online payment request containing rendering check information, verifies the rendering check information against the stored check information packet, and makes a payment to a merchant system according to the online payment request. The electronic check processing module may be embodied in a check server connected to user terminals and merchant systems. The connection may be through a suitable network such as an intranet and the Internet.

The online payment system and method help to solve the problems of long payment processing times and excessive exposure to security risks in the existing technologies.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an online payment system commonly used for online commerce today.

FIG. 2 illustrates an example of an alternative online payment system in the existing technologies.

FIG. 3 illustrates an online payment system using an electronic check system in accordance with the present disclosure.

FIG. 4 shows a flowchart illustrating an exemplary process used in the online payment method in accordance with the present disclosure.

FIG. 5 illustrates an exemplary online payment system in accordance with the present disclosure.

FIG. 6 shows a flowchart of an exemplary process using the online payment system of FIG. 5.

FIG. 7 shows a flowchart of a check application process using the online payment system of FIG. 5.

FIG. 8 illustrates another exemplary online payment system in accordance with the present disclosure.

FIG. 9 shows a flowchart of an exemplary process using the online payment system of FIG. 8.

FIG. 10 shows a flowchart of an exemplary process using e-currencies to recharge an electronic check account.

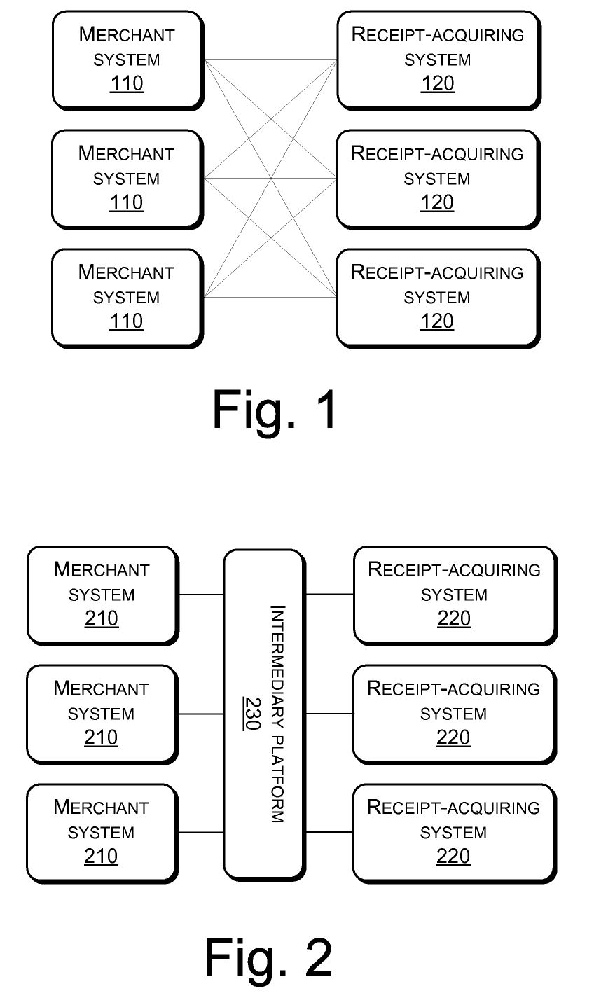

### DETAILED DESCRIPTION

### An Overview

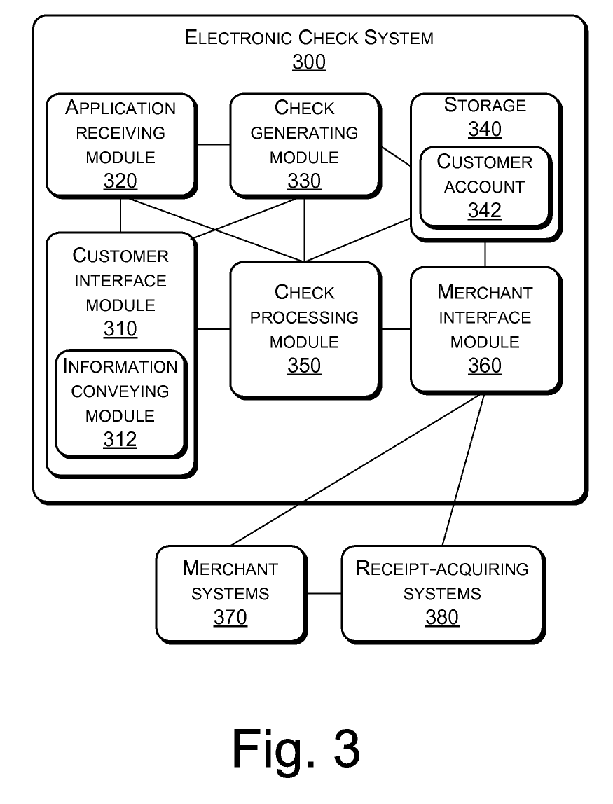

FIG. 3 illustrates an online payment system using an electronic check system in accordance with the present disclosure. The electronic check system 300 has multiple modules to perform interactive functions. A customer interface module 310 is used for interfacing between the electronic check system 300 and an online payment customer (not shown). The customer may use the customer interface module 310 in various scenarios including applying for a new electronic check, recharging a customer account and requesting an online payment. The customer interface module 310 may include an information conveying module 312 to send information back to the customer. An application receiving module 320 is used to receive an electronic check application from the customer. A check generating module 330 generates a check information packet based on the electronic check application. The check information packet may include an electronic check number and a check password for verification. Storage 340 is used for storing the check information packet.

Central to the electronic check system 300 is a check processing module 350 which is used to receive an online payment request containing rendering check information, verify the rendering check information against the stored check information packet, and make a payment to a merchant system 370 according to the online payment request. A receipt-acquiring system 380 may be used to work with a corresponding merchant system 370 to further facilitate the completion of the online payment. In the example shown in FIG. 3, the merchant systems 370 and the receipt-acquiring systems 380 (there can be any number of both such systems) are external to the electronic check system but are interactively connected thereto.

The application receiving module 320, the check processing module 350, and other components of the electronic check system 300, maybe connected through an intranet, an Internet, or special designated lines.

As will be illustrated in further detail later, the application receiving module 320 may be a part of a user terminal. The check generating module 320 may also be part of the user terminal. Alternatively, the check generating module 330 may be, together with the check processing module 350, part of a check server. The storage 340 may also be part of the check server.

The electronic check system may further include a security module connected to the check generating module 330. The security module encrypts the check information packet before sending it to the customer.

The electronic check system 300 may further include a customer account 342 to fund electronic checks. A fund of an appropriate amount can be debited from the customer account at 342 to fulfill the customer's online payment request. The customer account 342 may be opened and recharged online using various funding methods including cash and e-currencies. The customer account 342 may be stored in the storage 340.

The customer account 342 may be replenished by the customer using a customer deposit. To manage the customer account 342, an account recharging module may be used to receive a recharge request from the customer, create an order form based on the recharge request and send the order form to a receipt-acquiring system (such as the receipt-acquiring system 380) to complete an account recharge. A security module may be connected to the account recharging module to encrypt recharging request by the customer.

It should be noted that separate customer interfaces may be used for different functions. In one embodiment, for example, the online payment request is received through one of the merchant systems 370, which may either share customer interface module 310 or use its own customer interface module (not shown). In some embodiments, the online payment request may be received through an intranet or the Internet without first going through the merchant systems 370. In this configuration, additional order information may still be needed from the merchant system 370 of the merchant with whom the customer is conducting a transaction.

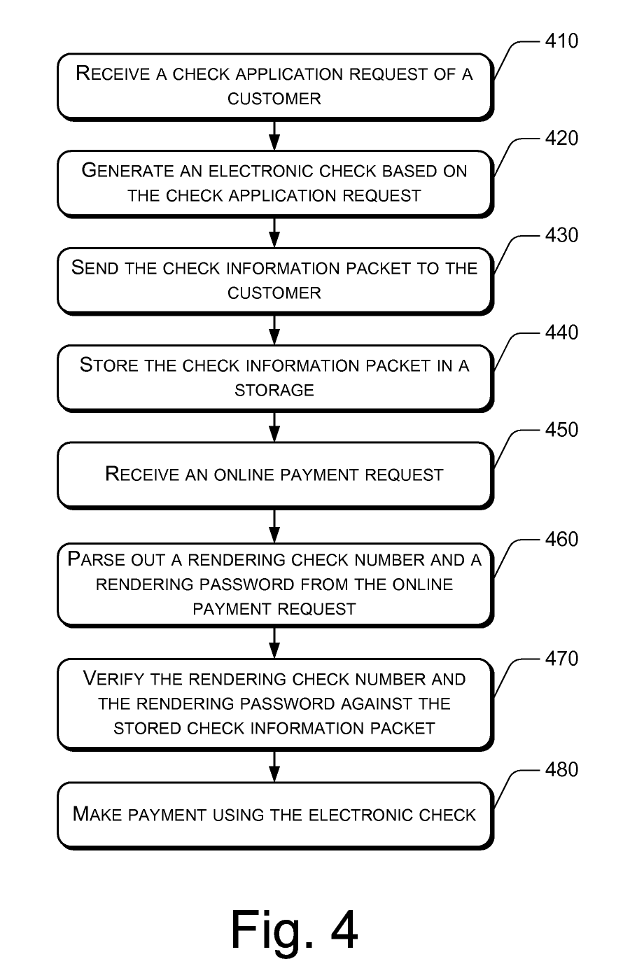

Furthermore, the information conveying module 312 may be a separate module, rather than a part of the customer interface module 310. The customer interface module 310 may either be separate from the application receiving module 320 or be contained therein as a part thereof FIG. 4 shows a flowchart illustrating an exemplary process used in the online payment method in accordance with the present disclosure. The process uses the electronic check system 300 of FIG. 3. In this description, the order in which a process is described is not intended to be construed as a limitation, and any number of the described process blocks may be combined in any order to implement the method, or an alternate method.

At block 410, the electronic check system 300 receives a check application request of a customer.

At block 420, the check generating module 330 generates an electronic check based on the check application request. The electronic check has a check information packet including a check number and a password.

At block 430, the information conveying module 312 sends the check information packet to the customer. The check information may be sent by printing or transmitting the electronic check number and the check password to the customer. Alternatively, the check information may be sent by writing the electronic check number and the check password on a removable memory device (such as a USB flash drive) accessible to the customer. The check information may also be saved on a network location and downloaded by the customer later. To insure security, the electronic check number and the check password may be encrypted into an encrypted file before sent to the customer.

At block 440, the system stores the check information packet in the storage 540.

At block 450, the system receives an online payment request. The online payment request may be received through customer interface module 310, or through one of the merchant systems 370. The online payment request contains payment check information. To ensure security, the online payment request may be encrypted.

At block 460, the check processing module 350 parses out a rendering check number and a rendering password from the online payment request received.

At block 470, the check processing module 350 verifies the rendering check number and the rendering password against the stored check information packet.

At block 480, the electronic check system 300 makes a payment using the electronic check. The payment may be made to the requested merchant system 370, and may be further assisted by the corresponding receipt-acquiring system 380. However, it is noted that once the rendering electronic check has been verified, the online payment may be completed without requiring participation of a receipt-acquiring system 380. Furthermore, even when a receipt-acquiring system 380 is used, the merchant system 370 does not need to transact with a different receipt-acquiring system 380 for each payment involving a different customer with a different bank.

To make the payment, the check processing module 350 may deduct an amount from a customer account according to the verified electronic check, and send the payment processing result to the merchant system 370. In one embodiment, the check processing module 350 may determine whether the payment is successful and notify the customer of the payment.

The process of FIG. 4 may further incorporate an account recharging process in which the check processing module 350 receives a customer recharge request for recharging customer account 342, generates a recharge order form based on the recharge request, sends the recharge order form to a receipt-acquiring system 380, and recharges customer account 342 after receiving a notice from the receipt-acquiring system indicating that the recharge order form has been successfully processed. The process of FIG. 4 may further incorporate other account management procedures such as performing an account check with the merchant systems 370 periodically.

Compared with the existing technology, the system and method disclosed herein accesses a centralized electronic check system (300) in each payment process. The process flow is simple, efficient and fast. In the payment process there is no need for the merchant to connect with each bank's receipt-acquiring system for each payment. The merchant only needs to ensure a continuous communication with the electronic check system (300). The presently disclosed online payment system and method reduces substantially the costs of developing and using an online payment system, and at the same time ensures data security for the banks. The system and method further provides an online recharge process through banks to bring convenience to customer. The electronic check system (300) of the present disclosure can be realized using the existing communication systems including postal systems and does not require a customer to visit a local office or a service point of a qualified bank before making an online payment. This enables customers in some geographic areas that do not have access to a bank having online payment capabilities to make online payments when using online trade services.

### More Exemplary Embodiments

The online payment system and method are described in further detail below using the figures and exemplary embodiments.

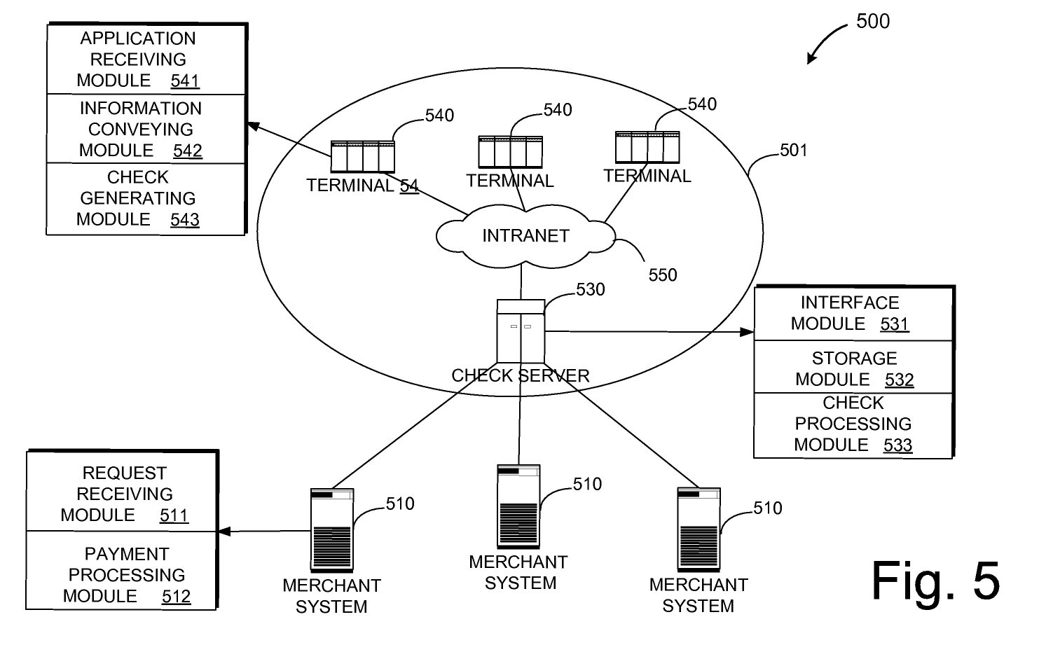

FIG. 5 illustrates an exemplary online payment system in accordance with the present disclosure. The online payment system 500 has merchant systems 510 and an electronic check system 501. The electronic check system 501 includes a check server 530 and terminals 540. Terminals 540 and check server 530 are connected together through a special designated line or an intranet 550.

Check processing software may be installed either on check server 530 or terminals 540. For the purpose of illustration, the check processing software in the example is installed on terminals 540. With respect to functionality, terminal 540 may have several major components including application receiving module 541, information conveying module 542 and check generating module 543.

The application receiving module 541 is used to receive check application of a customer. The check application may be an initial application with a request for opening a customer account or an application requesting for drawing a check from an existing customer account. The check application may also come with a customer account recharge request, such as a recharge form filled by the customer. The recharge form may include customer information and recharge amount. The customer information may include customer identity information and customer authentication information. The recharge amount is entered by customer for the present electronic check. Application receiving module 541 saves the check application and recharge information. Application receiving module 541 may also first print the information out for verification by the customer and then enter the information into account to be saved.

Check generating module 543 is used to create a check information packet which contains electronic check number and corresponding check password and output the check information to the customer. To be more concrete, check generating module 543 creates an electronic check number corresponding to the present electronic check. There are many different ways of producing an electronic check number, but usually the method used needs to ensure the uniqueness and randomness of the electronic check number. For example, check generating module 543 may create a unique electronic check number according to the identity card, date and the payment amount entered by the customer. One exemplary electronic check number is made up from the first 6 digits of identity card, followed by a 12-digit serial number, the last 3 digits of identity card and the last 2 digits of the payment amount. A serial number generator may be used to create the 12-digit serial number. The serial number generator may use a method based on the principle of exclusivity. For instance, when generating a new serial number, the sera number generator first locks up the serial number, raises the current serial number by 1, then releases the serial number, and returns the new serial number created.

Check generating module 543 can use output equipment such as a printer to print out the electronic check number and corresponding check password, and deliver the printout to the customer. Check generating module 543 can also directly provide an encrypted file to the customer after encrypting the created electronic check number and the corresponding check password using a security module. For example, check generating module 543 can save the encrypted file into a USB flash drive accessible by the customer.

There are many ways to encrypt an electronic check number and the corresponding check password. One can use any of the existing encryption algorithms to do encryption. An example is used in the following to demonstrate how to create an encrypted file for a customer. When a customer needs to trade with a merchant, the merchant's web site usually employs membership for management. After check generating module 543 creates an electronic check number and check password, it may use the username of the customer on the merchant's web site to encrypt the electronic check number and check password. When the customer needs to make an online payment, the online payment system 500 requires the merchant to send the username and the corresponding encrypted file to the check server 530 for decryption in order to obtain the customer's electronic check number and check password. This process can increase the security of online payment.

The information conveying module 542 is used to send the customer information entered by customer and the check information to check server 530 for storage. Information conveying module 542 normally considers an electronic check as a unit, and returns the customer information as well as the electronic check information including the electronic check number, check password and check amount, to the check server 530 to be saved.

Application receiving module 541, information conveying module 542 and check generating module 543 are logical units, and not required to be separate physical units. In terms of physical entities, the functions of these logical units can be performed by the processor of the terminal 540. Besides a processor, terminal 540 may also include printers and other output units for conveying the electronic check number and check password to the customer. In order to ensure the security of data sent between terminal 540 and check server 530, in each data transmission between terminal 540 and check server 530, the sending end may perform encryption and the receiving end may perform corresponding decryption.

Merchant system 510 has request receiving module 511 and payment processing module 512. The request receiving module 511 is used to receive online payment request of the customer who wishes to use an electronic check for online trade. When requesting for making an online payment, the customer can directly enter electronic check number and check password, or provide the encrypted file that contains electronic check number and check password to be read by merchant system 510. Request receiving module 511 organizes the acquired information into an online payment request message and sends the message to check server 530. The online payment request message may also include the present payment amount, a swift number, etc. Merchant system 510 can also include a security module used for encrypting messages (e.g., the online payment request message) sent to the electronic check system 501 and decrypting messages received from the electronic check system 501. Correspondingly, check server 530 also has a corresponding security module installed for decrypting a received message and encrypting a sent message. The payment processing module 512 is used to inform the customer after confirming the payment is successful based on the processing result returned from the electronic check system 501.

The check server 530 has multiple modules including interface module 531, storage module 532 and check processing module 533. The interface module 531 is used to establish communication with the merchant, such as receiving an online payment request from merchant system 510 and returning a response result to merchant system 510.

Storage module 532 is used to store the customer information and the electronic check information sent from terminal 540. Storage module 532 may belong to the check server 530 (i.e., constituting a part thereof), or a separate storage device such as a database server. Storage module 532 may establish an electronic check database using electronic check numbers as indexes. Each electronic check number corresponds to one electronic check which includes customer information of the electronic check, status information and balance information. The status information includes whether the electronic check is valid or invalid. Balance information is the current amount held by the electronic check.

The check processing module 533 is used to handle an online payment request. Specifically, the check processing module 533 first verifies the electronic check number and check password parsed out from the online payment request. For a payment request that has been successfully verified, the check processing module 533 processes a fund deduction or a debit transaction, and returns the processing result to the merchant system 510. To perform verification, the check processing module 533 first obtains an electronic check number and a check password from online payment request message. The electronic check number and the check password obtained this way may be referred to as the rendering electronic check number and the rendering check password, as they are being rendered for verification in order to make a payment. The check processing module 533 then checks the rendering electronic check number and the rendering check password against the electronic check numbers and the check passwords stored in the electronic check database one the storage module 532. If the rendering number and password match an existing valid electronic check number and check password in the current electronic check database, the validation of the rendering electronic check number and the rendering check password succeeds. The check processing module 533 then processes the debit transaction (fund deduction) for the payment request. For example, the check processing module 533 deducts the payment amount of the present online payment from the balance of the electronic check shown in the database. If the net result is not negative, debit transaction is successful. The check processing module then stores the difference as the new net balance of the corresponding electronic check in the electronic check database.

In addition, online payment system 500 may use one-time electronic checks. After the check has been used for once, the corresponding status in electronic check database is set to an “invalid” state. If the amount in electronic check is larger than the payment amount, the remaining balance will appear in the account of the customer in online payment system 500. The remaining balance may be used for creating another check, but cannot be used for the same check.

The electronic check system 501 may also include a security module that corresponds to the first security module of the terminal 540. The second security module is used to parse out electronic check number and check password from the encrypted file contained in the online payment request using decryption.

The online payment system 500 disclosed herein only requires a single interaction between the merchant system 510 and the electronic check system 501 for each online payment process, and thus greatly improves the speed of the online payment process. Moreover, the online payment system disclosed herein does not need to go through financial institutions such as the banks for each payment, thus helping to reduce the cost of the online payment. Furthermore, within each online payment process, there is no need to enter the information of a bank card and password. Rather, only an electronic check number and check password (or encrypted file that has electronic check number and check password) are entered. An owner of a bank card may use the bank card for opening a new account or recharging an existing account on the electronic payment system, but does not need to expose the bank card information in each online payment. As a result the method can effectively protect important customer information.

Merchant system 510 and electronic check system 501 can perform account check, either manually or through account check software. Each time a merchant sends an online payment request, the request message contains a swift number and a corresponding merchant's code. Electronic check system 501 keeps the processing result of each online payment request and the corresponding swift number as well as the merchant's code. At the same time, the merchant retains the swift number of the online payment request. Merchant system 510 and electronic check system 501 perform an account check and process account remittance through corresponding swift numbers kept on each side. Each merchant system 510 may include an account checking module to perform an account check operation with check server 530. The check server 530 has its own account checking module to perform an account check operation with each merchant system 510.

Electronic check recharge may also be done online. To do this, the electronic check system 501 may include a recharging module used to receive a recharge request of the customer, make the recharge request into an order form request and send it to a receipt-acquiring system. Upon receiving from the receipt-acquiring system a processing result indicating that order form has been successfully processed, the recharging module recharges the customer account accordingly. If the customer has also requested that an electronic check be created with recharging, the electronic check system 501 may create a check information packet having an electronic check number and a corresponding check password, and outputs the check information packet to the customer. The electronic check system 501 may also include a security module that connects to the recharging module. The security module is used to establish secure interaction with the receipt-acquiring system. For example, after creating each order form request, the security module first sends a secret key request to the receipt-acquiring system; and after obtaining a public key from the returned response, encrypts the order form request. This implementation of online payment will be explained in more details below.

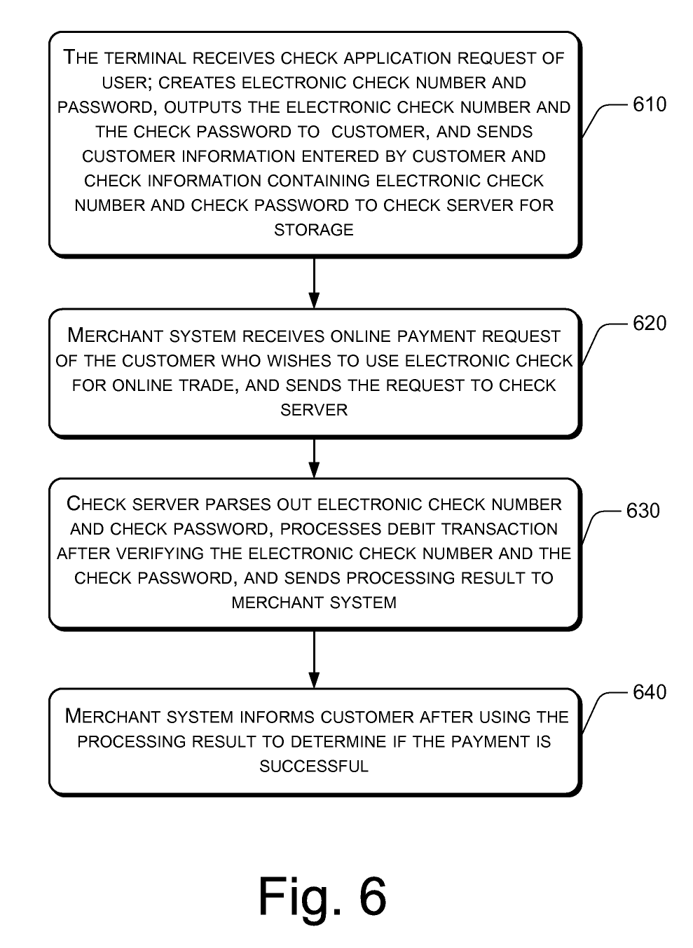

FIG. 6 shows a flowchart of an exemplary process using the online payment system of FIG. 5. The process is described as follows.

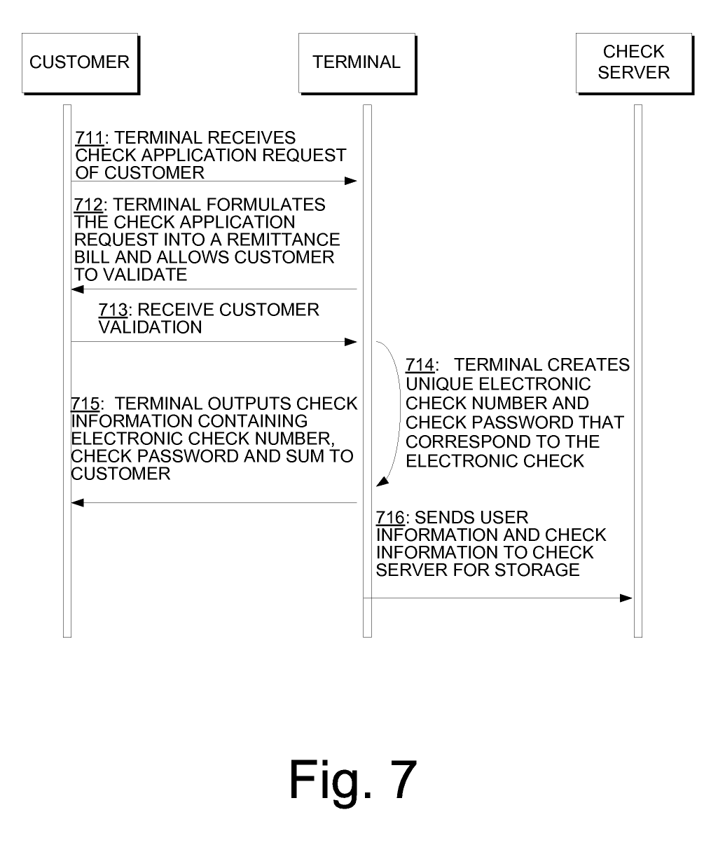

At 610, terminal 540 receives check application request of the customer, creates an electronic check number and password, outputs the electronic check number and the check password to customer, and sends the customer information entered by the customer and the check information containing the electronic check number and check password to check server 530 for storage. An exemplary process for check application will be described in further detail in FIG. 7.

At 620, merchant system 510 receives an online payment request of the customer who wishes to use an electronic check for network trade, and sends the request to check server 530.

When doing online trade, the customer enters the electronic check number and the check password to send out a payment request. Merchant system 510 organizes the online payment request into an online payment request message. This can be done by adding the merchant's code, swift number, trade amount, etc., into a pre-defined message format to be organized into the online payment request message and sent to electronic check system 501. The customer may also first upload the encrypted file to merchant system 510 and send the payment request subsequently. In this case, the online payment request message sent by merchant system 510 will contain the uploaded encrypted file.

At 630, check server 530 parses out an electronic check number and a check password, processes a debit transaction after verifying the electronic check number and the check password, and sends the processing result to merchant system 510.

If the online payment request message received by check server 530 is not encrypted and contains a straight electronic check number and check password, check server 530 may directly parses out the electronic check number, check password, swift number, merchant's code and the amount of payment. Check server 530 uses the parsed electronic check number and check password to search pre-stored electronic check database, and determine if there exists a matching electronic check number and check password. If a matching electronic check exists and is in a valid state, validation passes. Otherwise, validation fails. If validation passes, a debit transaction is performed. Check server 530 stores processing instances of each online payment and sends the processing result to merchant system 510.

If the online payment request message received by check server 530 contains encrypted file, check server 530 first decrypts the encrypted file and then parses out the electronic check number and check password from the decrypted file. The rest of the process is similar to above.

At 640, merchant system 510 informs the customer after determining if this payment is successful using the processing result.

As shown above, the transaction process described herein can be very simple. An electronic check can be applied to any online merchant, as long as the merchant is connected to the electronic check system (e.g., 501) described herein. The merchant is not required to ensure communication with multiple receipt-acquiring systems during payment. This greatly improves the speed of online payment and at the same time significantly reduces development cost. Furthermore, the electronic check system can accept recharge using either e-currencies or other types of currencies. This provides customers more user-friendly services, and gives more options to the customers.

FIG. 7 shows a flowchart of a check application process using the online payment system of FIG. 5. To check application process is described as follows.

At 711, terminal 540 receives check application request of the customer. The request contains information such as username, identity card information and amount.

At 712: terminal 540 formulates the check application request into a remittance bill format, and allows the customer to verify the check application request.

At 713, terminal 540 receives customer's verification.

At 714, terminal 540 creates a unique electronic check number and check password associated with an electronic check.

At 715, terminal 540 outputs the check information containing electronic check number, check password and the payment amount to the customer. One option of output is to let terminal print the check information and deliver it to the customer. Another option is to let terminal 540 output an encrypted file of the electronic check information to the customer. For example, terminal 540 may save the encrypted file in a removable USB flash drive of the customer, or save the encrypted file in a network drive for the customer to download.

At 716, terminal 540 sends the customer information and the check information to check server 530 for storage (e.g., in an electronic check database).

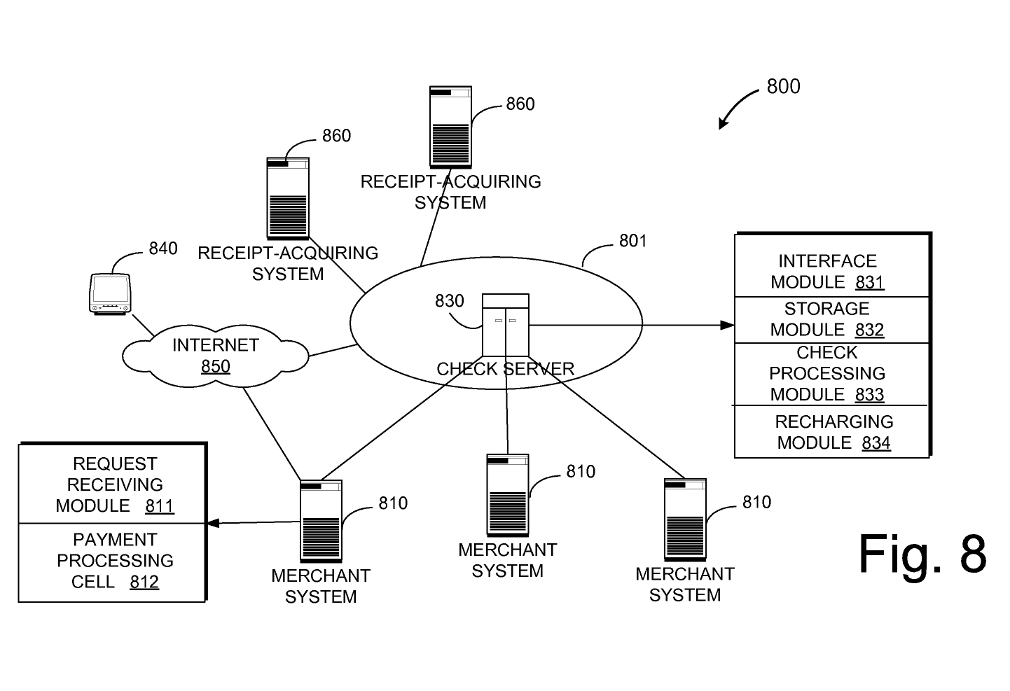

FIG. 8 illustrates another exemplary online payment system in accordance with the present disclosure. Online payment system 800 includes electronic check system 801, merchant systems 810 and receipt-acquiring systems 860. The electronic check system 801 has a check server 830. The merchant systems 810 each connects with check server 830. The electronic check system 801 connects with receipt-acquiring systems 860. Compared to the online payment system 500 of FIG. 5, the primary difference in online payment system 800 is in the application by the customer for an electronic check, as explained below.

Each merchant system 810 includes request receiving module 811 and payment processing module 812. The request receiving module 811 is used to receive an online payment request of the customer who wishes to use an electronic check for online trade, and send the online payment request to check server 830. The payment processing module 812 is used to inform the customer after confirming the payment is successful based on the processing result returned from check server 830.

The check server 830 includes recharging module 844, in addition to interface module 831, storage module 832 and check processing module 833. The recharging module 844 is used to receive a recharge request of a customer who accesses electronic check system 801 using a user terminal 840 through the Internet 850. User terminal 840 may be a regular PC with no electronic check generation software installed. As shown below, the electronic check generation is performed by check server 830 in this configuration.

The recharging module 844 formulates the recharge request into an order form request to be sent to a corresponding receipt-acquiring system 860. After receiving from receipt-acquiring system 860 a processing result indicating that the order form processing is successful, recharging module 844 generates a check information packet having an electronic check number and a corresponding check password, and outputs the check information packet to the customer.

Alternatively, check server 830 may contain a separate check generation module (not shown) to generate electronic checks. In addition to generating a new electronic check for an existing customer account during recharging (as described above), check server 830 may generate a new check either for an existing customer account that already has a sufficient remaining balance, or for new customer account that is being created with sufficient funds.

Check server 830 may print the electronic check number, the check password and the amount to be customer directly, or encrypt such information into an encrypted file and then send the encrypted file to the customer, for example using a removable USB drive. It can also upload the encrypted file to a network location and allow the customer to download encrypted file. The content of the encrypted file may contain a signature and a customer number (or a user ID) used by the merchant system 860 for the customer. The signature is used to prevent data from being tampered. The customer number is to prevent file from being used by another person without permission.

Similar to that in FIG. 5, the interface module 831 is used to establish communication with the merchant systems 810, such as receiving an online payment request from a merchant system 810 and returning a response result to the merchant system 810. Storage module 832 is used to save the customer information and the check information. The processing module 833 is used to process the online payment request by verifying the electronic check number and the check password that are parsed from the online payment request, processing debit if the request passes verification, and returning the processing result to merchant system 810.

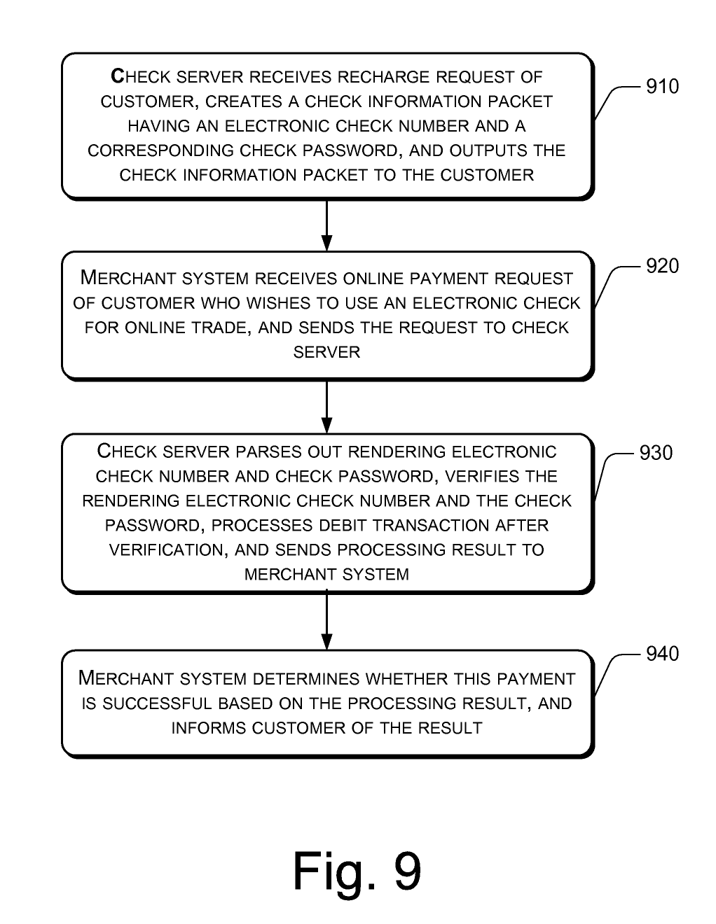

FIG. 9 shows a flowchart of an exemplary process using the online payment system of FIG. 8. The process is described as follows.

At 910, check server 830 receives recharge request of customer, and formulates the recharge request into an order form request to be sent to a corresponding receipt-acquiring system 860. Upon receiving from receipt-acquiring system 860 a processing result indicating that the order form processing has been successful, check server 830 creates a check information packet having an electronic check number and a corresponding check password, and outputs the check information packet to the customer. Check server 830 also saves the check information on storage module 832.

At 920, merchant system 810 receives online payment request of customer who wishes to use an electronic check for online trade, and sends the request to check server 830.

At 930, check server 830 parses out rendering electronic check number and check password, verifies the rendering electronic check number and the check password, processes debit transaction after verification, and sends processing result to merchant system 810.

At 940, merchant system 810 determines whether this payment is successful based on the processing result, and informs customer of the result.

The online payment method described above can use a receipt-acquiring system 960 to perform convenient online recharge, as described further below.

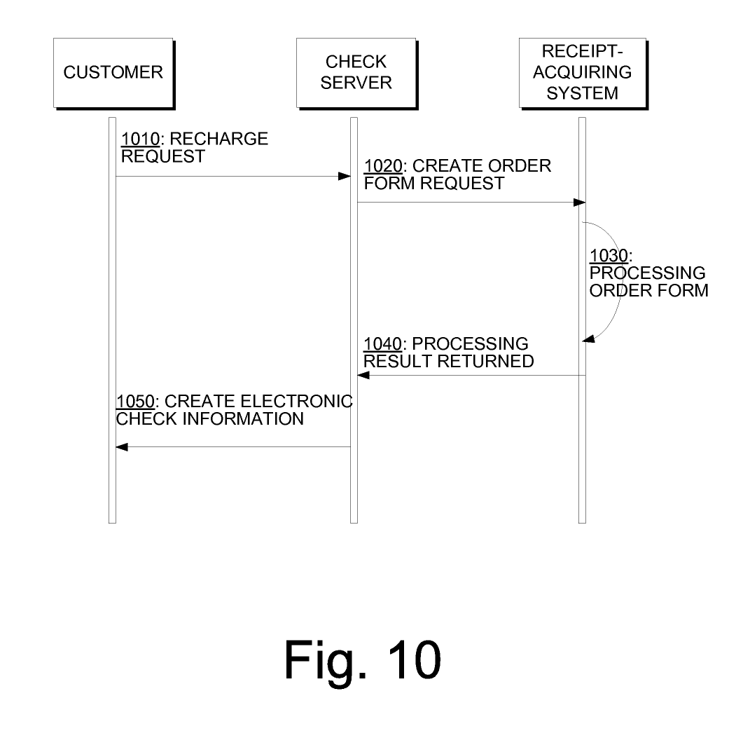

FIG. 10 shows a flowchart of an exemplary process using e-currencies to recharge an electronic check account. The process is performed through an online receipt-acquiring system, as described below.

At 1010, check server 830 receives recharge request of customer, including information such as bank card, password and recharge amount entered by the customer.

At 1020, check server 830 creates order form request from the recharge request and sends it to receipt-acquiring system 860. Check server 830 creates order form request message in a pre-defined format. The order form message may also contain electronic check identity information so that response of order form request can be returned timely. In order to increase security, each time when check server 830 sends an order form request, it first sends a secret key request to receipt-acquiring system 860. After obtaining a public key from the returned response, check server 830 encrypts the order form request.

At 1030, receipt-acquiring system 860 first examines the validity of the order form, and then processes the validated order form. For example, receipt-acquiring system 860 may determine beforehand whether the available fund in the bank card of the customer is larger than the recharge amount. If yes, process debit transaction. Otherwise, return a processing result to indicate insufficient fund.

At 1040, receipt-acquiring system 860 returns processing result to check server 830.

At 1050, check server 830 generates electronic check information such as electronic check number and check password for the successfully processed order, and outputs the electronic check information to the customer.

The online payment system and method are described above using several exemplary embodiments. It is appreciated that a storage used in the online payment system may be any computer readable media or any suitable memory device for storing computer data. Such memory devices include, but not limited to, hard disks, flash memory devices, optical data storages, and floppy disks. It is also appreciated that a check server in the present disclosure may be a server computer, or a cluster of such server computers, connected through network(s), which may either be Internet or an intranet.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An online payment system, comprising:
an application receiving module adapted to receive an electronic check application from a customer;
a check generating module adapted to generate a check information packet based on the electronic check application;
an information conveying module for sending the check information packet to the customer;
a storage for storing the check information packet; and
a check processing module adapted to receive an online payment request containing rendering check information, verify the rendering check information against the stored check information packet, and make a payment to a merchant system according to the online payment request.

2. The online payment system as recited in claim 1, wherein the application receiving module is a part of a user terminal.

3. The online payment system as recited in claim 1, wherein the check generating module is a part of a user terminal.

4. The online payment system as recited in claim 1, wherein the check generating module and the check processing module are part of a check server.

5. The online payment system as recited in claim 1, wherein the storage and the check processing module are part of a check server.

6. The online payment system as recited in claim 1, further comprising:
a security module connected to the check generating module, the security module being adapted to encrypt the check information packet before the check information packet is sent to the customer.

7. The online payment system as recited in claim 1, wherein the check information packet contains an electronic check number and a corresponding check password.

8. The online payment system as recited in claim 1, further comprising:
a security module for encrypting the check information packet.

9. The online payment system as recited in claim 1, wherein the application receiving module and the check processing module are connected through an intranet.

10. The online payment system as recited in claim 1, wherein the application receiving module and the check processing module are connected through the Internet.

11. The online payment system as recited in claim 1, wherein the online payment request is received through the application receiving module.

12. The online payment system as recited in claim 1, wherein the online payment request is received through the merchant system.

13. The online payment system as recited in claim 1, wherein the online payment request is received through an intranet or the Internet without first passing through the merchant system.

14. The online payment system as recited in claim 1, further comprising:
a customer account from which a fund can be debited to fulfill the customer's online payment request.

15. The online payment system as recited in claim 14, wherein the customer account is adapted to be able to be replenished using a customer deposit.

16. The online payment system as recited in claim 14, further comprising:
an account recharging module adapted to receive a recharge request from the customer, create an order form based on the recharge request and send the order form to a receipt-acquiring system to complete an account recharge.

17. The online payment system as recited in claim 14, further comprising:
an account recharging module adapted to recharge the customer account through a receipt-acquiring system; and
a security module connected to the account recharging module, wherein the security module interacts with the receipt-acquiring system to encrypt recharging request by the customer.

18. An online payment system, comprising:
a merchant system; and
an electronic check system connected to the merchant system, the electronic check systems including an application receiving module, a check generating module, an information conveying module, an interface module, a storage, and a check processing module,
wherein the application receiving module is used to receive a check application of a customer, the check generating module is used to generate an electronic check having check information and to output the check information to the customer and the check server, the information conveying module is used to send the check information to the check processing module, the interface module is used to receive an online payment request through the merchant system and return a response result to the merchant system, the storage is used to save the check information generated by the check generating module, and the check processing module is used to process the online payment request by verifying the electronic check number and the check password parsed from the online payment request and making a payment using the verified electronic check.

19. The online payment system as recited in claim 18, wherein the application receiving unit and the check generating unit are part of user terminal connected to the check processing unit.

20. The online payment system as recited in claim 18, wherein the payment interface unit, the storage and the check processing unit are part of a check server.

21. The online payment system as recited in claim 18, further comprising:
a customer account from which a fund can be debited to make the payment.

22. The online payment system as recited in claim 18, wherein the check processing unit is used to return a payment result to the merchant system.

23. An online payment method, comprising:
receiving at an electronic check system a check application request of a customer;
generating an electronic check based on the check application request, the electronic check having a check information packet including a check number and a password;
sending the check information packet to the customer;
storing the check information packet in a storage;
receiving an online payment request;
parsing out a payment check number and a payment password;
verifying the payment check number and the payment password against the stored check information packet; and
making a payment using the electronic check.

24. The online payment method as recited in claim 23, wherein making the payment using the electronic check comprises:
deducting an amount from a customer account according to the verified electronic check; and
sending a payment processing result to a merchant system.

25. The online payment method as recited in claim 23, further comprising:
determining whether the payment is successful; and
notifying the customer of the payment.

26. The online payment method as recited in claim 23, further comprising:
receiving a customer recharge request for recharging a customer account;
generating a recharge order form based on the recharge request;
sending the recharge order form to a receipt-acquiring system; and
recharging the customer account after receiving a notice from the receipt-acquiring system indicating that the recharge order form has been successfully processed.

27. The online payment system as recited in claim 23, wherein sending the electronic check number and the check password to the customer comprises:
printing or transmitting the electronic check number and the check password to the customer.

28. The online payment system as recited in claim 23, wherein sending the electronic check number and the check password to the customer comprises:
writing the electronic check number and the check password on a removable memory device accessible to the customer.

29. The online payment system as recited in claim 23, further comprising:
encrypting the electronic check number and the check password into an encrypted file; and
outputting the encrypted file to the customer.

30. The online payment system as recited in claim 23, wherein the online payment request is received through a merchant system.

31. The online payment system as recited in claim 23, wherein the online payment request is encrypted.

32. The online payment system as recited in claim 23, further comprising:
performing an account check with a merchant system periodically.
